(19) United States
(12) Patent Application Publication
(10) Pub. No.: US 2024/0253949 A1
(43) Pub. Date: Aug. 1, 2024

(54) ADJUSTABLE ELEVATOR LANDING ARCHITRAVES FOR ELEVATOR LANDING DOORWAY ASSEMBLIES

(71) Applicant: Otis Elevator Company, Farmington, CT (US)

(72) Inventors: Guillaume Montigny, Gien (FR); Sebastien Fougeron, Lorris (FR); Alexandre Renard, Coullons (FR); Deqi Liu, Puteaux (FR); Jerome Marais, Saint Firmin sur Loire (FR); Stephane Brieuc, Poilley Lez Gien (FR); Thierry Bongibault, Gien (FR); Amine Badaoui, Briare (FR); Thierry Spitz, Puteaux (FR); Jean-Pierre Tantis, Chatillon sur loire (FR)

(21) Appl. No.: 18/524,637

(22) Filed: Nov. 30, 2023

(30) Foreign Application Priority Data
Jan. 30, 2023 (EP) 23305112.7

(51) Int. Cl. B66B 13/30

(52) U.S. Cl. CPC B66B 13/306

(57) ABSTRACT

An adjustable elevator landing architrave (300) for an elevator landing doorway assembly (400). The adjustable elevator landing architrave (300) includes a first piece (100) for arranging next to an elevator landing door system (410), the first piece (100) having a first length in an overlap direction, for at least partially obscuring the doorframe (420) from view; and a second piece (200) having a first width for at least partially obscuring from view a portion (406) of the elevator landing door system (410) extending beyond the doorframe (420); the second piece (200) further having a first length in the overlap direction, for at least partially overlapping with the first length of the first piece (100) to define an adjustable overlap length (301). The overall length (302) of the adjustable elevator landing architrave (300) can be adjusted dependent on the adjustable overlap length (301).

### FOREIGN PRIORITY

This application claims priority to European Patent Application No. 23305112.7, filed Jan. 30, 2023, and all the benefits accruing therefrom under 35 U.S.C. § 119, the contents of which in its entirety are herein incorporated by reference.

### TECHNICAL FIELD

This disclosure relates to adjustable elevator landing architraves for elevator landing doorway assemblies. This disclosure also relates to an elevator landing doorway assembly and a method of installing an adjustable elevator landing architrave into an elevator landing doorway assembly.

### BACKGROUND

Elevator landing door systems are installed next to doorframes, which may be cut out between an inner and outer wall of a landing. There is often variation in the walls on different landings relative to the elevator hoistway. This can create a gap between the elevator landing door system and the inner wall of a landing, which varies in size between landings. There is also often a variation in wall thickness between different landings. This can further increase the variation in the distance between the outer wall of a landing and the elevator landing door system on different landings of the same elevator system. Clearly, there will also be significant variation in these distances between different elevator systems. These gaps can be unsightly, and in some cases could present a safety risk to the passenger, and/or could interfere with proper operation of the elevator system.

Doorframes in elevator landing doorway assemblies are not always cut precisely into the wall of a landing. This can result in a misalignment between the elevator landing door system and its respective doorframe. Typically, if the doorframe is too small in any given dimension, it will need to be widened. However, often the doorframe extends too far in one or more dimensions. In these instances, part of the elevator landing door system may extend inwardly beyond the doorframe. This can be unsightly, and in some cases could present a safety risk to the passenger and/or could interfere with proper operation of the elevator system. In addition to this, the elevator doorframe can be cut unevenly into the wall of a landing, which can also be unsightly.

For at least the reasons stated above, an elevator landing architrave is desirable as both an aesthetic and functional component of an elevator landing doorway assembly. An elevator landing architrave can be used to cover the gap between the elevator landing door system and the inner wall of a landing. An elevator landing architrave can also be used to cover the doorframe itself, and the extension of the elevator landing door system beyond the doorframe.

Due to the variation in the required dimensions of the elevator landing architrave at least for the reasons stated above, elevator landing architraves are typically made to measure for each landing. Alternatively, elevator landing architraves are cut to size on site, which is a time consuming, often inaccurate, and relatively unsafe process. This process also creates a lot of waste on site.

There is therefore a need for an adjustable elevator landing architrave which can be installed adjustably on site to accommodate a range of distances between the elevator landing door system and the outer wall of a landing.

### SUMMARY

When viewed from a first aspect, the present disclosure provides an elevator landing doorway assembly comprising: an elevator landing door system; a doorway in a wall, the doorway comprising a doorframe for the elevator landing door system, defined between an inner face and an outer face of the wall; and an adjustable elevator landing architrave comprising: a first piece arranged next to the elevator landing door system and having a first length, in a direction perpendicular to the elevator landing door system, for at least partially obscuring the doorframe from view; and a second piece having a first width for at least partially obscuring from view a portion of the elevator landing door system extending beyond the doorframe; the second piece further having a first length, in the direction perpendicular to the elevator landing door system, that has at least a partial overlap with the first length of the first piece to define an adjustable overlap length; wherein an overall length of the adjustable elevator landing architrave is equal to a sum of the first length of the first piece and the first length of the second piece minus the adjustable overlap length; and wherein the overall length of the adjustable elevator landing architrave covers at least a distance between the elevator landing door system and the outer face of the wall in the direction perpendicular to the elevator landing door system.

It will be appreciated that in such an elevator landing doorway assembly the adjustable elevator landing architrave can be adjusted, dependent on the adjustable overlap length, to cover the distance between the elevator landing door system and the outer face of the wall and therefore obscure from view the doorway and any gap between the doorway and the elevator landing door system installed behind the doorway.

When viewed from a second aspect, the present disclosure provides an adjustable elevator landing architrave for an elevator landing doorway assembly, the elevator landing doorway assembly comprising: an elevator landing door system; and a doorway in a wall, the doorway comprising a doorframe for the elevator landing door system, defined between an inner face and an outer face of the wall; wherein the adjustable elevator landing architrave comprises: a first piece having a first length, in an overlap direction, for at least partially obscuring the doorframe from view; and a second piece having a first width for at least partially obscuring from view a portion of the elevator landing door system extending beyond the doorframe; the second piece further having a first length in the overlap direction, for at least partially overlapping with the first length of the first piece to define an adjustable overlap length; wherein an overall length of the adjustable elevator landing architrave is equal to a sum of the first length of the first piece and the first length of the second piece minus the adjustable overlap length; and wherein the overall length of the adjustable elevator landing architrave can be adjusted dependent on the adjustable overlap length.

It will be appreciated that the adjustable overlap length may be pre-adjusted according to the expected layout of the elevator landing doorway assembly and/or adjusted during installation of the adjustable elevator landing architrave. For example, during installation, the first piece may be arranged next to an elevator landing door system so as to at least partially obscure the doorframe from view and then the second piece may be arranged to overlap with the first piece dependent on the adjustable overlap length.

In some examples, the overall length of the adjustable elevator landing architrave is adjusted to cover, in use, at least a distance between the elevator landing door system and the outer face of the wall in the direction perpendicular to the elevator landing door system.

There will now be described various examples and features which may apply to an elevator landing doorway assembly or an adjustable elevator landing architrave as disclosed above.

The elevator landing door architrave could be flush with the outer face of the outer wall, or in some examples it could only extend partially along the length of the doorway. In various examples, the first length of the second piece extends at least partly past the outer face of the wall. In these examples, the architrave can obscure an edge of the doorframe between the doorframe and the outer face of the wall and therefore hide any unevenness of the doorframe from view.

The first length of the first piece could fully obscure the doorframe from view. In various examples, the first length of the second piece, in combination with the first length of the first piece, obscures the doorframe from view.

In some examples, the first piece further comprises a height in a direction perpendicular to the first length. The first piece may be an elongate piece having a height that is much greater than its first length. The height of the first piece may be chosen to match the height of the doorframe. In some examples, the second piece further comprises a height in a direction perpendicular to the first length and first width of the second piece. The height of the second piece may be at least the height of the doorframe and possibly more than the height of the doorframe. The second piece may be an elongate piece having a height that is much greater than its first length and/or its first width.

The second piece could be unattached and instead be supported in place, without the need for any attachment. In some examples, the second piece is attached to the first piece. In some examples, the second piece is attached to the outer face of the wall. In some examples, the second piece is attached to the doorframe. In various examples, the second piece is attached to any combination of the first piece, the outer face of the wall and the doorframe. Minimising the number of points of attachment improves the ease of installation, while each successive attachment may provide more support to the architrave.

The second piece could be attached to the outer face of the wall in any number of ways, including drilling through the second piece and bolting it to the outer face of the wall. In some examples, the second piece comprises a second length, extending from the first width, for attaching (e.g. directly or indirectly) the second piece to the outer face of the wall; wherein the second length extends between the outer face of the wall and the first width, for example perpendicular to the first width. By virtue of the second length extending between the outer face of the wall and the first width, the first width can partially obscure the second length from view, and therefore attaching the second piece to the outer face of the wall using this second length may allow the, often unsightly, attachment to be at least partially obscured from view.

The second length of the second piece may be attached to the outer face of the wall by any suitable means, such as fasteners (bolts, rivets, etc.), welding, adhesive, snap-fit, etc. In some examples, the adjustable elevator landing architrave further comprises at least one wall mounting bracket for attaching (e.g. the second length of) the second piece to the outer face of the wall; wherein the at least one wall mounting bracket is attached to the second length of the second piece and the outer face of the wall. For example, a plurality of wall mounting brackets may be arranged along the height of the second piece to attach the second piece to the outer face of the wall.

In some examples, the first width of the second piece, and optionally the second length of the second piece, extends further than the first length of the second piece along the height of the second piece. In these examples, this extension of the first width results in a height that may extend above the doorframe (e.g. when the architrave is installed vertically) and may be used to improve the overall aesthetic finish of an elevator landing doorway assembly.

In some examples, the second piece is a sheet material. In some examples, the second piece is sheet metal.

In some examples, the second piece comprises an L-shape, wherein the L-shape consists of the first width of the second piece and the second length of the second piece. For example, the second piece may be a sheet material that is folded to form this L-shape.

In some examples, the second piece comprises an L-shape, wherein the L-shape consists of the first length of the second piece and the first width of the second piece. For example, the second piece may be a sheet material that is folded to form this L-shape.

In some examples, the second piece comprises an overall J-Shape, wherein the J-Shape consists of the first length of the second piece, the first width of the second piece, and the second length of the second piece. For example, the second piece may be a sheet material that is folded to form the overall J-shape.

The second piece could be attached to the first piece in any number of ways, including drilling through both pieces and bolting them together. In some examples, the first piece comprises a second length, parallel to the first length, for attaching the second piece to the first piece; wherein the second length extends between the doorframe and the first length. By virtue of the second length being between the doorframe and the first length, the first length can obscure the second length from view, and therefore attaching the second piece to the first piece using this second length may obscure the, often unsightly, attachment from view.

In some examples, the second length of the first piece is smaller than the first length of the first piece.

In some examples, the adjustable elevator architrave comprises one or more clips arranged between the first length of the second piece and the second length of the first piece. For example, the clips can be attached (e.g. pre-attached) to the first length of the second piece for attaching the second piece to the second length of the first piece, or vice versa. This may be a particularly convenient embodiment, as by virtue of the clips, no fixture, fitting, hole, or similar attachment means is required on the first piece for attaching to the second piece (or vice versa). For example, the clips may grip onto an edge of the second length of the first piece.

In some examples, the first piece is a sheet material. In some examples, the first piece is sheet metal.

In various examples, the first width of the second piece fully obscures the portion of the elevator door system extending beyond the doorframe from view. In various examples, the first piece has a first width, and the first width of the first piece in combination with the first width of the second piece obscures the portion of the elevator door system extending beyond the doorframe from view. The first width of the second piece, and optionally the first width of the second piece, may be defined in a direction generally parallel to the elevator landing door system. This direction may be generally parallel to the outer face of the wall.

The first piece is arranged next to elevator landing door system and may be supported against elevator landing door system. In some examples, the first piece is attached (e.g. directly or indirectly) to the elevator landing door system. In some examples, the first piece has a first width for attaching the first piece to the elevator landing door system. This first width may be defined in a direction generally parallel to the elevator landing door system. This direction may be generally parallel to the inner face of the wall.

In some examples, the first piece comprises a J-Shape, wherein the J-Shape comprises the first length of the first piece being connected to the second length of the first piece. For example, the first piece may be a sheet material that is folded to form the J-shape. This is a particularly convenient arrangement, as the second length can easily be used to attach the second piece to the first piece, while being obscured from view by the first length of the first piece. In some examples, the J-Shape of the first piece further comprises a second width of the first piece which connects the first length to the second length.

The first piece is arranged (e.g. during installation) next to the elevator landing door system. The adjustable overlap length may be used to ensure that the first piece touches the elevator landing door system so that there is no gap left between them. The first piece may be at least partially supported by the elevator landing door system. In some examples, the first piece is attached to the elevator landing door system.

In some examples, the elevator landing door system comprises protrusions, and the first width of the first piece defines apertures located over the protrusions to attach the first piece to the elevator landing door system. The protrusions and the apertures can be pre-formed and therefore make installation easy and more accurate.

In some examples, the elevator landing doorway assembly further comprises at least one pad attached to the doorframe for providing support to the adjustably installed elevator landing architrave. For example, a plurality of pads may be arranged along the height of the doorframe to support the architrave.

In some examples, the at least one pad has a width that is adjustable. This is particularly beneficial to account for variations in the distance between the doorframe and the adjustably installed elevator landing architrave.

In some examples, the elevator landing doorway assembly comprises at least two adjustable elevator landing architraves. In some examples, the elevator landing doorway assembly comprises three adjustable elevator landing architraves. In some of these examples, one adjustable elevator landing architrave is for a first, vertical, side of the doorway, a second adjustable elevator landing architrave is for a second, vertical, side of the doorway and the third adjustable elevator landing architrave is for a top, horizontal, side of the doorway.

According to a further aspect, there is also disclosed herein a method of installing such an adjustable elevator landing architrave into an elevator landing doorway assembly. The method comprises: determining a required length for the adjustable overlap length so that the adjustable elevator landing architrave has an overall length covering at least a distance between the elevator landing door system and the outer face of the wall in the direction perpendicular to the elevator landing door system; and installing the first piece and the second piece of the adjustable elevator landing architrave according to the required length of the adjustable overlap length.

In some examples, the method further comprises installing at least one pad on the doorframe. In some examples, this step comprises drilling at least one hole into the doorframe and screwing the at least one pad into the at least one hole.

In some examples, the method further comprises adjusting the width of the at least one pad.

In some examples, the method further comprises attaching the first piece to the elevator landing door system. Optionally, the method further comprises locating apertures of the first piece onto protrusions of the elevator landing door system.

In some examples, the method further comprises attaching the second piece to the outer face of the wall. Optionally, the method further comprises attaching one or more wall mounting brackets to the second piece and further comprises attaching the one or more wall mounting brackets to the outer face of the wall.

In some examples, the method further comprises attaching the first piece to the second piece. Optionally, the method further comprises attaching one or more clips to the second piece and clipping the first piece to the second piece (or vice versa).

In some examples, the method comprises installing a plurality of adjustable elevator landing architraves. In some examples, the method comprises installing two adjustable elevator landing architraves (e.g. vertically). In some examples, the method comprises installing three adjustable elevator landing architraves (e.g. two vertically and one horizontally).

### BRIEF DESCRIPTION OF DRAWINGS

One or more non-limiting examples will now be described, by way of example only, and with reference to the accompanying figures in which:

FIG. 1a shows a first piece of an adjustable elevator landing architrave;

FIG. 1b shows a three-dimensional view of the first piece of FIG. 1a;

FIG. 2a shows a second piece of an adjustable elevator landing architrave;

FIG. 2b shows a three-dimensional view of the second piece of FIG. 2a;

FIG. 3a shows an adjustable elevator landing architrave comprising the first piece of FIGS. 1a and 1b and the second piece of FIGS. 2a and 2b;

FIG. 3b shows the adjustable elevator landing architrave of FIG. 3a adjusted to correspond with a different distance between the elevator landing door system and the outer face of a wall comprising a doorframe for the elevator landing door system;

FIG. 4a shows an elevator landing doorway assembly, comprising the adjustable elevator landing architrave of FIGS. 3a and 3b;

FIG. 4b is another Figure of the elevator landing doorway assembly of FIG. 4a highlighting various distances of significance;

FIG. 5a shows an elevator landing doorway assembly, comprising three of the adjustable elevator landing architraves of FIGS. 3a and 3b;

FIG. 5b shows another view of the elevator landing doorway assembly of FIG. 5a showing the doorframe between the inner and outer face of the wall; and

FIG. 6 is an example of a method of installation of an elevator landing doorway assembly.

### DETAILED DESCRIPTION

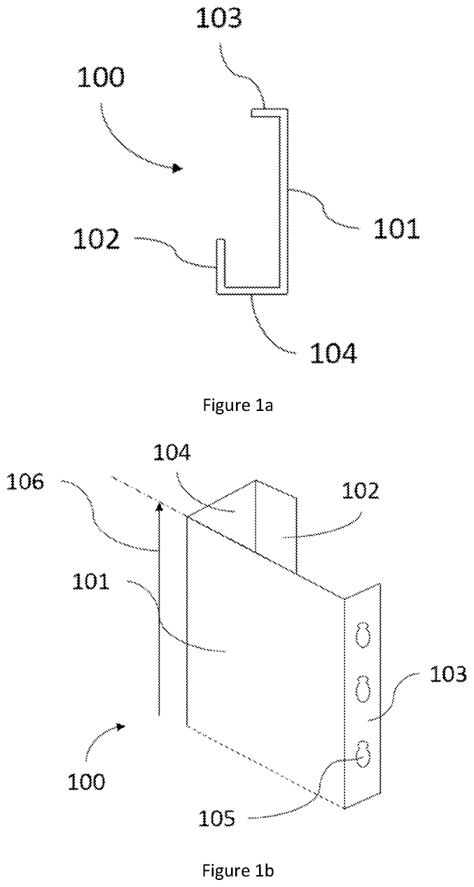

Referring to FIGS. 1a and 1b, a first piece 100 of an adjustable elevator landing architrave comprises a first length 101, a second length 102, a first width 103, and a second width 104.

In this example, the first piece 100 is made from sheet metal. In this example, the first piece 100 comprises a fold to form a L-Shape between the first width 103 and the first length 101. In this example, the first piece comprises two folds to form a J-Shape between the first length 101, the second width 104 and the second length 102.

In this example, the first width 103 defines apertures 105 for attaching the first piece to an elevator landing door system.

In this example, the first piece 100 has a height 106. Here, the height 106 is equal to the height of a doorframe so as to obscure the doorframe from view along its height.

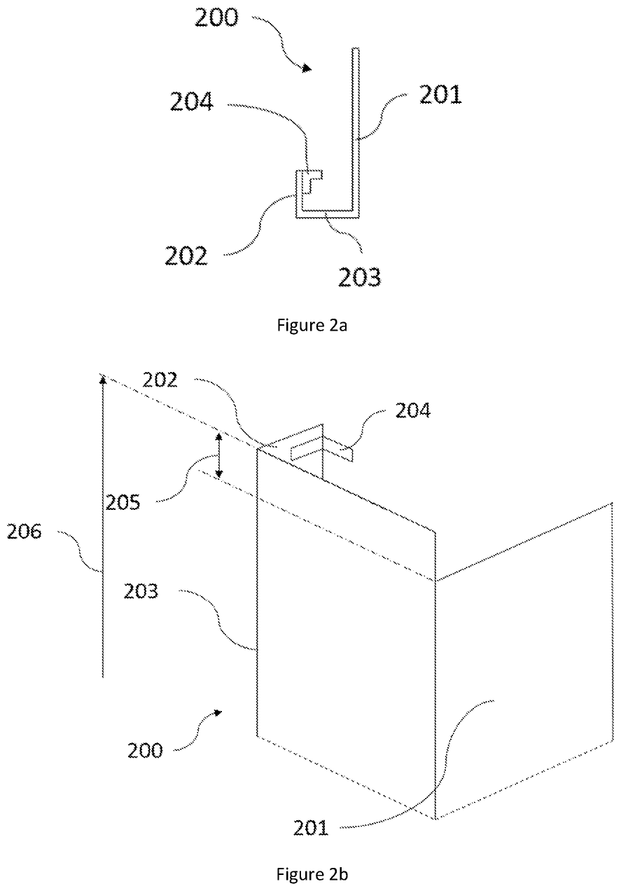

Referring to FIGS. 2a and 2b, a second piece 200 of an adjustable elevator landing architrave comprises a first length 201, a second length 202, and a first width 203. A wall mounting bracket 204 is attached to the second length 202 of the second piece 200.

In this example, the second piece 200 is made from sheet metal. In this example, the second piece comprises a fold to form an L-shape between the first length 201 and the first width 203. In this example, the second piece 200 comprises another fold to form an L-shape between the first width 203 and the second length 202.

In this example, the second piece 200 has a height 206. Here, the height 206 is greater than the height of a doorframe. The portion of the height 206 greater than the height of the doorframe is the length 205 of the extension.

In this example, the first width 203 and the second length 202 extend higher than the first length, in order to extend above the top of a doorway. The length 205 of the extension is shown in the figure. In this example, a wall mounting bracket 204 is secured to the second length 202 for mounting the second piece 200 to a wall. While in this example, the wall mounting bracket 204 is riveted to the second piece 200, one skilled in the art will appreciate alternative methods of attaching the two pieces such as gluing, bolting, screwing, etc., are all equally suitable for securing the wall mounting bracket to the second piece. Furthermore, while in this figure the wall mounting bracket 204 is attached to the second piece 200 and not yet attached to the wall; in various examples the wall mounting bracket 204 is first attached to the wall and then riveted to the second piece 200. As can be seen from FIGS. 1a and 1b, the wall mounting bracket 204 is hidden from view by virtue of being behind the first width 203, and therefore results in a more aesthetically pleasing attachment to the wall than various alternative methods, such as drilling through the first width 203 to attach the second piece 200 to the wall directly.

In some embodiments, the wall mounting bracket could be replaced by a second width, behind the first width 203, and the second width could instead be used to secure the second piece 200 to the wall. When the second piece is a sheet material, a fold in the material may exist forming an L-Shape between the second length 202 and the second width.

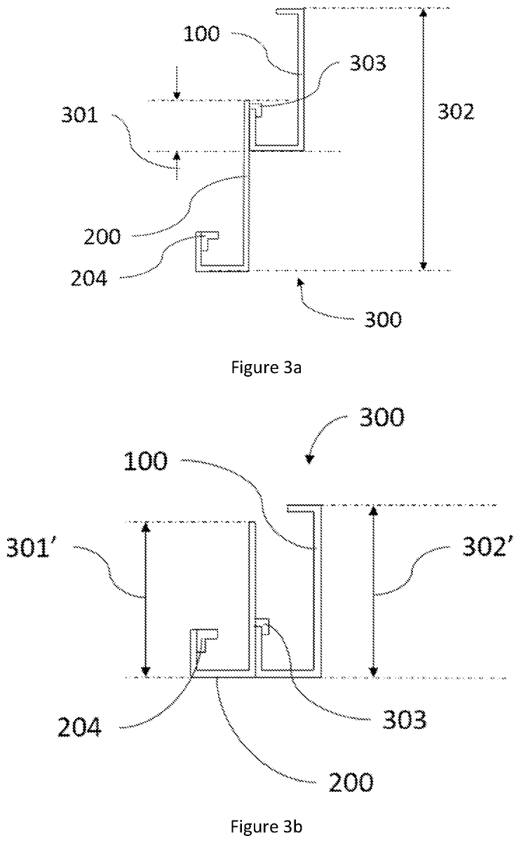

Referring to FIG. 3a, with continued reference to FIGS. 1a, 1b, 2a and 2b, an adjustable elevator landing architrave 300 comprises the first piece 100 of FIGS. 1a and 1b, the second piece 200 of FIGS. 2a and 2b, and the wall mounting bracket 204 of FIGS. 2a and 2b. The first length 101 of the first piece 100 partially overlaps with the first length 201 of the second piece 200. The overlap length 301 is shown in the figure. A longer overlap length 301 will result in a shorter overall length 302 of the adjustable elevator landing architrave 300, while a shorter overlap length 301 will result in a longer overall length 302 of the adjustable elevator landing architrave 300.

In this example, the second piece 200 is attached to the second length 102 of the first piece 100. Various means of attachment are feasible, such as gluing, bolting together, riveting together, etc. In this example, the two sections are clipped together by attaching a plurality of clips 303 to the first length 201 of the second piece 200. In this example, the clips 303 are secured to the first length 201 of the second piece 200 to correspond with a required overall length 302 of the adjustable elevator landing architrave 300. This is a particularly convenient embodiment, as the clips will clip onto the end of the second length 102 of the first piece 100 without requiring any holes, or fixtures etc. to be present on the second length 102 of the first piece 100. However, it will be apparent to one skilled in the art that if holes in the first piece 100 were required, these could be pre-drilled, while corresponding holes, fixtures, fittings, etc. in the second piece 200 can be arranged as part of the installation process to correspond with the desired overlap length 301. Alternatively, the second piece 200 could be pre-arranged and fittings, etc., in the first piece 100 can be made to measure in the installation process.

In this example, attaching the second piece 200 to the second length 102 of the first piece 100 ensures that the clips 303 are obscured from view by the first length 101 of the first piece 100.

Referring to FIG. 3b, with continued reference to FIGS. 1a, 1b, 2a, 2b, and 3a, the length 301′ of the partial overlap is adjusted to minimise the overall length 302′ of the adjustable elevator landing architrave 300. In this example, the first length 101 of the first piece 100 fully overlaps with the first length 201 of the second piece 200.

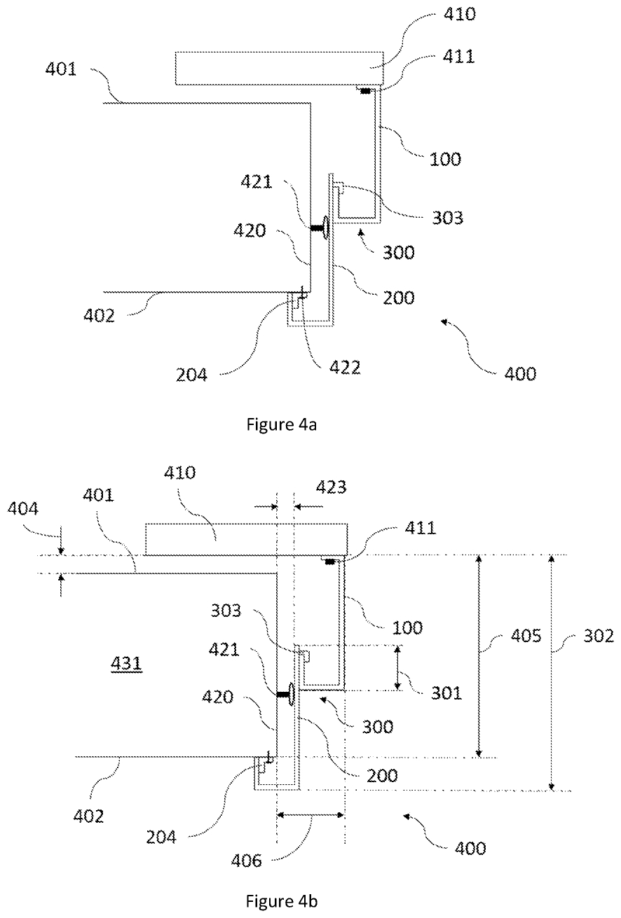

Referring to FIG. 4a, with continued reference to FIGS. 1a, 1b, 2a, 2b, 3a, and 3b, an elevator landing doorway assembly 400 comprises the adjustable elevator landing architrave 300 of FIGS. 3a and 3b, an elevator landing door system 410, a doorframe 420 for the elevator landing door system 410 defined between an inner face 401 and an outer face 402 of a wall 431.

In this example, the first piece 100 is attached to the elevator landing door system 410. In this example, the elevator landing door system 410 comprises protrusions 411 for locating the first piece 100 of the adjustable elevator landing architrave 300. In this example, the first width 103 of the first piece 100 defines apertures 105 for the protrusions 411 of the elevator landing door system 410. In this example, the apertures 105 and protrusions 411 are pre-formed and therefore the assembly of the elevator landing doorway assembly 400 is particularly easy and accurate. In this example, the first length 101 of the first piece 100 obscures the first width 103 of the first piece 100 from view, and therefore it obscures the attachment of the first piece 100 to the elevator landing door system 410 from view. This can prevent tampering with the attachment and has beneficial aesthetic properties.

In this example, the second piece 200 of the adjustable elevator landing architrave 300 is attached to the outer face 402 of the wall 431. In this example, the wall mounting bracket 204 is screwed into the outer face 402 of the wall 431 using screws 422, however various means of attaching the second piece to the outer face 402 of the wall 431 will be obvious to one skilled in the art. In this example, as the wall mounting bracket 204 is screwed to the outer face 402 of the wall 431, the screws 422 used to attach the wall mounting bracket 204 to the outer face 402 of the wall 431 are obscured from view by the first width 203 of the second piece 200. This can prevent tampering with the attachment and has beneficial aesthetic properties.

In this example, the elevator landing doorway assembly 400 further comprises several pads 421. These pads 421 are attached to the doorframe 420 and provide support to the adjustable elevator landing architrave 300. In this example, the pads 421 are shown as supporting the second piece 200 of the adjustable elevator landing architrave 300, however they could equally be used to support the first piece 100 or both the first 100 and second 200 pieces. In some examples, the pads 421 are attached to the adjustable elevator landing architrave 300 to provide greater support.

Referring to FIG. 4b, with continued reference to FIGS. 1a, 1b, 2a, 2b, 3a, 3b, and 4a; in this example each pad 421 has an adjustable width 423 to accommodate a range of distances between the doorframe 420 and the adjustable elevator landing architrave 300. The distance between the doorframe 420 and the adjustable elevator architrave 300 can vary across the doorframe 420 and therefore it is particularly beneficial for the width 423 of each pad 421 to be able to be adjusted independently to accommodate for the variation in this distance, while still providing support to the adjustable elevator architrave 300. In this example, the width 423 of the pad 421 is equal to the distance between the doorframe 420 and the adjustable elevator landing architrave 300.

In this example, the distance 405 between the elevator landing door system 410 and the outer face 402 of the wall 431 comprises a gap 404 between the elevator landing door system 410 and the inner face 401 of the wall 431. This gap 404 can vary in size between landings and therefore it is particularly beneficial to be able to adjust the length 301 of the overlap between the first piece 100 and the second piece 200 of the adjustable elevator landing door architrave 300 in order to accommodate a range of distances 405 between the landing door system 410 and the outer face 402 of the wall 431, and therefore a range of gap 404 sizes. Variation in wall 431 thickness can also contribute towards the variation of the distance 405 between the landing door system 410 and the outer face 402 of the wall 431.

In this example, the doorframe 420 is wider than is required and therefore a portion 406 of the elevator landing doorway assembly extends beyond the doorframe. The first width 103 of the first piece 100 of the adjustable elevator architrave 300, in combination with the first width 203 of the second piece 200 of the adjustable elevator landing architrave 300, obscure the portion 406 of the elevator door system 410 extending beyond the doorframe 420 from view. This provides a good aesthetic finish to the elevator landing doorway assembly 400 and protects the various attachments from tampering, as well as providing various other benefits.

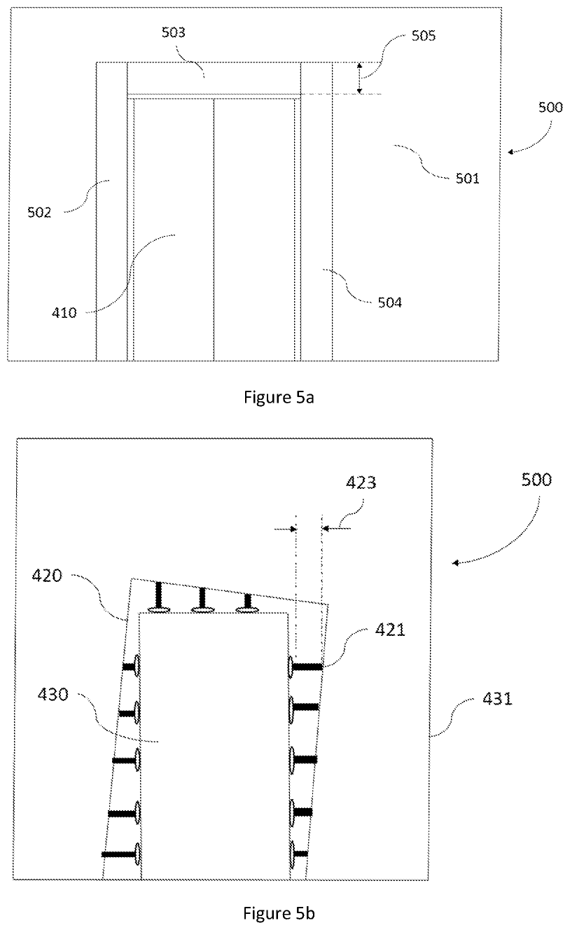

Referring to FIG. 5a, an elevator landing doorway assembly 500 comprises three adjustable elevator landing architraves 502, 503, 504 which may be the same type as the adjustable elevator landing architrave 300 of FIGS. 3a, 3b, 4a, and/or 4b. A first architrave 502 covers the left-hand side of the doorframe, a second architrave 503 covers the top of the doorframe, and a third architrave 504 covers the right-hand side of the doorframe. The doorframe for the elevator landing doorway assembly 500 is defined in the wall 431. It will be appreciated that the elevator landing architrave 300 of FIGS. 3a, 3b, 4a, 4b is designed to be installed as the left-hand architrave 502, while the right-hand architrave 504 may be a mirror image of the elevator landing architrave 300. In this example, the vertical adjustable elevator landing architraves 502, 504 extend vertically above the doorframe by a length 505 (corresponding to the extension 205 seen in FIG. 2b) to create a better aesthetic finish of the elevator landing doorway assembly 500. In this example, the horizontal adjustable landing architrave 503 does not comprise such an extension but may otherwise match the elevator landing architrave 300 of FIGS. 3a, 3b, 4a, 4b. In another version of the elevator landing doorway assembly 500, the horizontal architrave 503 includes an extension at each end and the vertical architraves 502, 504 do not include the extension length 505.

Referring to FIG. 5b, another view of the elevator landing doorway assembly 500 of FIG. 5a, FIG. 5b highlights that adjusting the width 423 of the pads 421 can accommodate for variations in the size and position of the doorframe 420. FIG. 5a also highlights why it is often important to hide the doorframe 420 using an architrave 300 to provide a nice aesthetic finish to an elevator landing doorway assembly 500.

Also shown in FIG. 5b is the doorway 430 of the elevator landing doorway assembly 500. This doorway 430 is the passage through which passengers enter and exit the elevator. The doorway comprises the doorframe 420, defined between the inner face and the outer face of the wall 431, also shown in FIG. 5b.

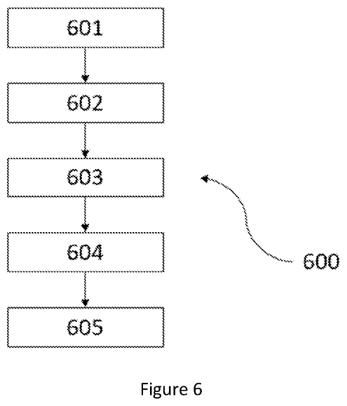

Referring to FIG. 6, with continued reference to FIGS. 1a, 1b, 2a, 2b, 3a, 3b, 4a, 4b, 5a and 5b, an example of a method 600 of installing an adjustable elevator landing architrave 300, 502, 503, 504 is provided.

In this example, the method 600 comprises a step 601 wherein the pads 421 are installed on the doorframe 420. In some examples, this comprises drilling holes into the doorframe 420 for the pads 421, and screwing the pads 421 into the doorframe 420.

In this example, the method 600 further comprises a step 602 of adjusting the widths 423 of the pads 421.

In this example, the method 600 further comprises a step 603 of determining a required adjustable overlap length 301, 301′ so that the adjustable elevator landing architrave 300, 502, 503, 504 has an overall length 302, 302′ covering at least a distance 406 between the elevator landing door system 410 and the outer face 402 of the wall.

In this example, the method 600 further comprises a step 604 of installing the first piece 100 and the second piece 200 of the adjustable elevator landing architrave 300, 502, 503, 504 according to the required adjustable overlap length 301, 301′. In this example, this step comprises attaching the first piece 100 to the elevator landing door system 410, by locating the apertures 105 of the first piece 100 using the protrusions 411 on the elevator landing door system 410. In this example, this step also comprises attaching the first piece 100 to the second piece 200, and further comprises attaching the second piece 200 to the outer face of the wall 402. In this example, attaching the second piece 200 to the outer face of the wall 402 comprises attaching wall mounting brackets 204 to the wall and riveting the second piece 200 to the wall mounting brackets 204. In this example, attaching the first piece to the second piece comprises attaching clips to the second piece and clipping the second piece 200 to the first piece 100.

In this example, the method 600 further comprises a step 605 of Installing a plurality of architraves 300, 502, 503, 504 as per the method to install one architrave 300.

While presented in the order according to FIG. 6, it will be understood that the steps of this method 600 can be carried out in any one of several possible orders.

What is claimed is:

1. An elevator landing doorway assembly (400, 500) comprising:
an elevator landing door system (410);
a doorway (430) in a wall (431), the doorway (430) comprising a doorframe (420) for the elevator landing door system (410), defined between an inner face (401) and an outer face (402) of the wall;
and an adjustable elevator landing architrave (300; 502, 503, 504) comprising:
a first piece (100) arranged next to the elevator landing door system (410) and having a first length (101), in a direction perpendicular to the elevator landing door system (410), for at least partially obscuring the doorframe (420) from view;
and a second piece (200) having a first width (203) for at least partially obscuring from view a portion (406) of the elevator landing door system (410) extending beyond the doorframe (420);
the second piece (200) further having a first length (201), in the direction perpendicular to the elevator landing door system (410), that has at least a partial overlap with the first length (101) of the first piece (100) to define an adjustable overlap length (301, 301′);
wherein an overall length (302, 302′) of the adjustable elevator landing architrave (300; 502, 503, 504) is equal to a sum of the first length (101) of the first piece (100) and the first length (201) of the second piece (200) minus the adjustable overlap length (301, 301′);
and wherein the overall length (302, 302′) of the adjustable elevator landing architrave (300) covers at least a distance (405) between the elevator landing door system (410) and the outer face (402) of the wall in the direction perpendicular to the elevator landing door system (410).

2. An elevator landing doorway assembly (400, 500) according to claim 1, wherein the second piece (200) is attached to the first piece (100).

3. An elevator landing doorway assembly (400, 500) according to claim 2, wherein the first piece (100) comprises a second length (102), parallel to the first length (101), for attaching the second piece (200) to the first piece (100); wherein the second length (102) extends between the doorframe (420) and the first length (101).

4. An elevator landing doorway assembly (400, 500) according to claim 3, wherein the first piece (100) comprises a J-Shape, and wherein the J-Shape comprises the first length (101) of the first piece (100) being connected to the second length (102) of the first piece (100).

5. An elevator landing doorway assembly (400, 500) according to claim 1, wherein the second piece (200) is attached to the outer face (402) of the wall (431).

6. An elevator landing doorway assembly (400, 500) according to claim 1, wherein the second piece (200) comprises a second length (202), extending from the first width (203), for attaching the second piece (200) to the outer face (402) of the wall (431); wherein the second length (203) extends between the outer face (402) of the wall (431) and the first width (203).

7. An elevator landing doorway assembly (400, 500) according to claim 1, wherein the second piece (200) has a height (206), and wherein the first width (203) of the second piece (200), and optionally the second length (202) of the second piece (200), extends further than the first length (201) of the second piece (200) along the height (206) of the second piece (200).

8. An elevator landing doorway assembly (400, 500) according to claim 1, wherein the first piece (100) is a sheet metal piece.

9. An elevator landing doorway assembly (400, 500) according to claim 1, wherein the second piece (200) is a sheet metal piece.

10. An elevator landing doorway assembly (400, 500) according to claim 1, wherein the first piece (100) is attached to the elevator landing door system (410).

11. An elevator landing doorway assembly (400, 500) according to claim 10, wherein the first piece (100) has a first width (103) for attaching the first piece (100) to the elevator landing door system (410).

12. An elevator landing doorway assembly (400, 500) according to claim 11, wherein the elevator landing door system (410) comprises protrusions (411), and the first width (103) of the first piece (100) defines apertures (105) located over the protrusions (411) to attach the first piece (100) to the elevator landing door system (410).

13. An elevator landing doorway assembly (400, 500) according to claim 1, further comprising at least one pad (421) attached to the doorframe (420) for providing support to the adjustably installed elevator landing architrave (300), wherein the at least one pad (421) has a width (423) that is adjustable.

14. An adjustable elevator landing architrave (300; 502, 503, 504) for an elevator landing doorway assembly (400, 500), the elevator landing doorway assembly (400, 500) comprising:
an elevator landing door system (410); and
a doorway (430) in a wall (431), the doorway (430) comprising a doorframe (420) for the elevator landing door system (410), defined between an inner face (401) and an outer face (402) of the wall (431);
wherein the adjustable elevator landing architrave (300; 502, 503, 504) comprises:
a first piece (100) having a first length (101), in an overlap direction, for at least partially obscuring the doorframe (420) from view;
and a second piece (200) having a first width (203) for at least partially obscuring from view a portion (406) of the elevator landing door system (410) extending beyond the doorframe (420);
the second piece (200) further having a first length (201) in the overlap direction, for at least partially overlapping with the first length (101) of the first piece (100) to define an adjustable overlap length (301, 301′);
wherein an overall length (302, 302′) of the adjustable elevator landing architrave (300; 502, 503, 504) is equal to a sum of the first length (101) of the first piece (100) and the first length (201) of the second piece (200) minus the adjustable overlap length (301, 301′);
and wherein the overall length (302, 302′) of the adjustable elevator landing architrave (300; 502, 503, 504) can be adjusted dependent on the adjustable overlap length (301, 301′).

15. A method (600) of installing an adjustable elevator landing architrave (300; 502, 503, 504) according to claim 14 into an elevator landing doorway assembly (400, 500), the method comprising:
determining (603) a required length for the adjustable overlap length (301, 301′) so that the adjustable elevator landing architrave (300; 502, 503, 504) has an overall length (302, 302′) covering at least a distance (406) between the elevator landing door system (410) and the outer face (402) of the wall in the direction perpendicular to the elevator landing door system (410); and
installing (604) the first piece (100) and the second piece (200) of the adjustable elevator landing architrave (300; 502, 503, 504) according to the required length of the adjustable overlap length (301, 301′).
